(19) United States
(12) Patent Application Publication
(10) Pub. No.: US 2007/0118851 A1
(43) Pub. Date: May 24, 2007

(54) Emergency alert signaling method and digital cable broadcast system

(76) Inventor: Chang Sik Yun, Gyeonggi-do (KR)

Correspondence Address: MCKENNA LONG & ALDRIDGE LLP, 1900 K STREET, NW, WASHINGTON, DC, 20006, US

(21) Appl. No.: 11/600,116

(22) Filed: Nov. 16, 2006

(30) Foreign Application Priority Data
Nov. 16, 2005 (KR) 10-2005-0109678

(51) Int. Cl. H04N 7/10; H04N 7/025; G08B 21/00

(52) U.S. Cl. 725/33; 340/687

(57) ABSTRACT

A digital cable broadcast system includes a broadcast receiver, a broadcast transmitter, and an alternative data receiver. The broadcast transmitter transmits a new emergency alert message associated with an emergency alert event if the broadcast receiver is not plugged into a power supply. More particularly, the transmitter transmits a status request to a cable mode or an out of band (OOB) included in the broadcast receiver, and it determines that the receiver is not plugged into the power supply if no response is received from the receiver. The alternative data receiver receives the new emergency alert message from the transmitter and displays the new emergency alert message in order to inform users.

This application claims the benefit of Korean Patent Application No. 10-2005-0109678, filed on Nov. 16, 2005, which is hereby incorporated by reference.

### BACKGROUND OF THE INVENTION

1. Field of the Invention

The present invention relates to Emergency alert signaling method and digital cable broadcast system.

2. Discussion of the Related Art

Generally, for TV sets on the market in North America, a basic protocol for handling an emergency alert message is laid down to prepare against an urgent situation or emergency.

Meanwhile, for cable digital televisions, a basic protocol for receiving an emergency alert message transmitted from a cable digital broadcasting station correctly and for handling the received message is laid down as well.

Differing from a digital TV receiving regular terrestrial broadcasting only, the cable digital TV is capable of receiving an emergency alert message via a specific frequency of terrestrial or cable broadcasting. In case that the emergency alert message arrives at a viewer watching the cable digital TV, the cable digital TV carries out a process for switching a current channel to a specific channel of the terrestrial or cable broadcasting and outputting the emergency alert message to efficiently provide the information about an emergency.

And, a basic protocol deals with various and complicated situations such as a method of returning to a channel a viewer has watched if an emergency ends and the like.

However, the related art method of handling the emergency alert message in cable broadcasting has the following problems.

First of all, if a power of a broadcast receiver capable of receiving cable digital broadcasting is turned off and if the receiver is in a plugged-out mode, there exists no method of notifying a user of information indicating an emergency occurrence.

Secondly, although a power of a broadcast receiver capable of receiving cable digital broadcasting is turned on, if the receiver is in a standby mode or if the receiver is outputting another data input source (e.g., the receiver is outputting A/V data received from a DVD player), it is unable to notify a user of information indicating an emergency occurrence.

### SUMMARY OF THE INVENTION

Accordingly, the present invention relates to Emergency alert signaling method and digital cable broadcast system.

An object of the present invention is to provide a method of processing an emergency alert message in bi-directional cable digital broadcasting, data structure thereof and broadcast receiver thereof, by which a user can be informed of an emergency occurrence if a power of a broadcast receiver capable of receiving cable digital broadcasting is turned off and if the receiver is in a plugged-out mode.

Another object of the present invention is to provide a method of processing an emergency alert message in bi-directional cable digital broadcasting, data structure thereof and broadcast receiver thereof, by which a user can be informed of an emergency occurrence if a power of a broadcast receiver capable of receiving cable digital broadcasting is turned on and if the receiver is in a standby mode or if the receiver is outputting another data input source (e.g., the receiver is outputting A/V data received from a DVD player).

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a digital cable broadcast system includes a broadcast transmitter, a broadcast receiver, and an alternative data receiver. The broadcast transmitter initially determines whether the broadcast receiver is plugged into a power supply. In order to determine this, the transmitter transmits a status request to the broadcast receiver to determine whether a cable card included in the broadcast receiver is active or not. If no response is received from the broadcast receiver, the transmitter determines that the cable card is not active and the broadcast receiver is not plugged into the power supply.

If the broadcast transmitter determines that the broadcast receiver is not plugged into the power supply, it transmits a new emergency alert message associated with an emergency alert event into the alternative data receiver. The data receiver receives the new emergency alert message from the broadcast transmitter and displays the message. Upon display of the alert message, a user is informed of the emergency alert event and can plug the broadcast receiver into a power supply.

After the broadcast receiver is plugged into the power supply, a controller included in the broadcast receiver determines whether the broadcast receiver is on a power-on mode or power-off mode. If it is on the power-off mode, the controller controls operation of a tuner included in the broadcast receiver to periodically tune to a predefined emergency alert channel to receive an emergency alert table (EAT). If the emergency alert table includes a new emergency alert message, the controller automatically sets the broadcast receiver on the power-on mode and further control operation of the tuner to tune to the emergency alert channel.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of an emergency alert message processing system in bi-directional cable digital broadcasting according to one embodiment of the present invention;

FIG. 2 is a block diagram of a broadcast receiver equipped with an emergency alert message processing function in bi-directional cable digital broadcasting according to one embodiment of the present invention;

FIG. 3 is a flowchart of a method of processing an emergency alert message in bi-directional cable digital broadcasting according to one embodiment of the present invention;

FIG. 4 is a diagram of a bit stream syntax of an emergency alert table according to one embodiment of the present invention;

FIG. 5 is a diagram of a meaning of “alert_priority” value according to one embodiment of the present invention; and

FIG. 6 is a flowchart of a method of processing an emergency alert message in bi-directional cable digital broadcasting according to another embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

First of all, for the clear explanation of the present invention, description about a method of processing EAM (emergency alert message) and the like in case that a power of a bi-directional cable DTV (digital television) is turned off’ and ‘description about a method of processing EAM (emergency alert message) and the like in case that a power of a bi-directional cable DTV (digital television) is in a standby mode’ are respectively explained as follows.

### First Embodiment

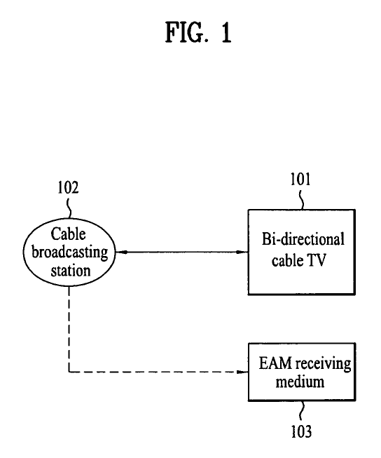

FIG. 1 is a block diagram of an emergency alert message processing system in bi-directional cable digital broadcasting according to one embodiment of the present invention. In case that a bi-directional cable DTV is off (plugged-out mode), a system capable of providing an emergency associated message to a user is explained in a general way with reference to FIG. 1 as follows.

Referring to FIG. 1, a cable broadcasting station 102 is connected to a cable broadcast receiver 101 via a cable. Even if a plug (not shown in the drawing) for supplying a power to the cable broadcast receiver 101 is off (plugged-out mode), the cable broadcasting station 102 can communicate with the cable broadcast receiver 101 via the cable.

Hence, the cable broadcasting station 102 decides whether the cable broadcast receiver 101 is in the plugged-out mode or not via communications.

Besides, the cable broadcast receiver 101 can be a bi-directional cable DTV capable of transmitting/receiving broadcast associated signals or the like for example.

The cable broadcasting station 102, which is connected to the cable broadcast receiver 101 to bi-directionally transmit/receive normal broadcast signals and data, can be a cable MSO (multiple system operator) or the like for example.

In case that the cable broadcast receiver 101 is in the plugged-off mode as a result of the decision made by the cable broadcasting station 102 and if information indicating that an emergency has occurred is confirmed, the cable broadcasting station 102 transmits the information indicating that the emergency has occurred to an EAM receiving medium 103. In doing so, the cable broadcasting station 102 confirms the information indicating that the emergency has occurred using an EAT (emergency alert table) and the like for example.

The EAM receiving medium 103 having received the information indicating that the emergency has occurred outputs the information in a format of text or the like.

In this case, the EAM receiving media 103 includes a wire phone, a mobile phone, a PDA or the like of a user of the cable broadcast receiver 101. Meanwhile, the EAM receiving medium 103 can be registered using information of a cable broadcasting subscriber. Alternatively, a user of the cable broadcast receiver can separately specify the EAM receiving medium 103 to register.

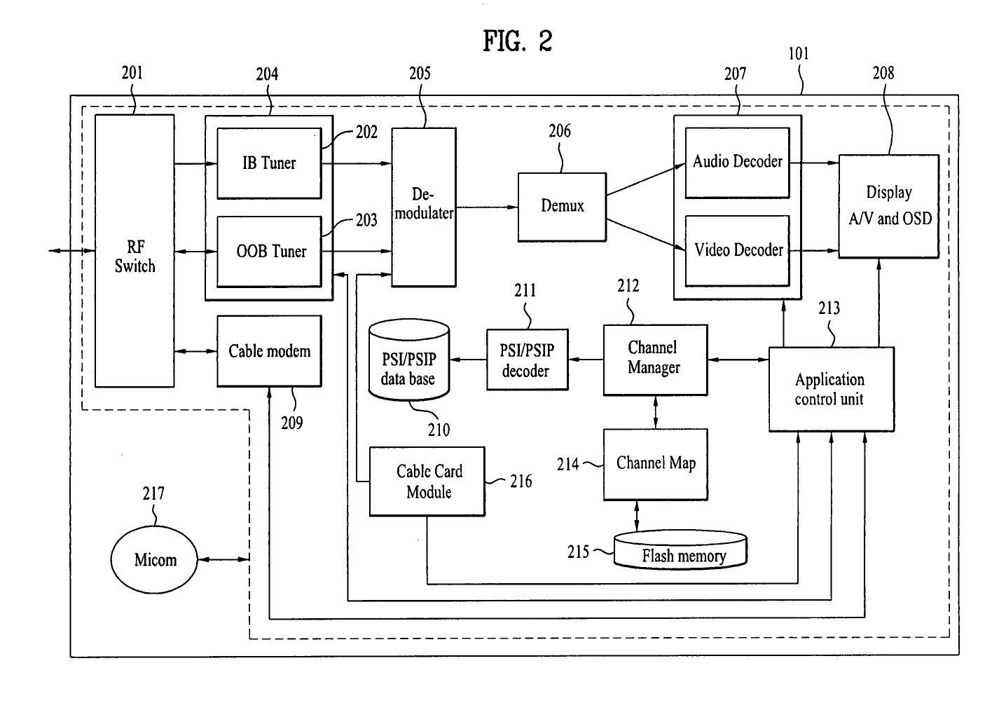

FIG. 2 is a block diagram of a broadcast receiver equipped with an emergency alert message processing function in bi-directional cable digital broadcasting according to one embodiment of the present invention. In case that a bi-directional cable DTV is in a plugged-out mode, a system capable of providing an emergency associated message to a user is explained in detail with reference to FIG. 2 as follows.

Referring to FIG. 2, a cable broadcast receiver 101 includes an RF switch 201, a tuner 204, a demodulator 205, a demultiplexer 206, an A/V decoder 207, a display unit 208, a cable modem 209, a PSI/PSIP database 210, a PSI/PSIP decoder 211, a channel manager 212, an application & UI controller 213, a channel map 214, a flash memory 215, a cable card module 216 and a microcomputer 217. For example, the cable broadcast receiver 101 includes a bi-directional digital television (DTV) or the like.

The tuner 204 receives a broadcast signal including a PSI/PSIP (program and system information/program and system information protocol) table. Yet, the PSIP table includes an EAT 9 emergency alert table) for example.

And, an operation of the tuner 204 is controlled by the channel manager 212.

In particular, the tuner includes an IB (in-band) tuner 202 receiving an in-band signal and an OOB (out-of-band) tuner 203 receiving an out-of-band signal.

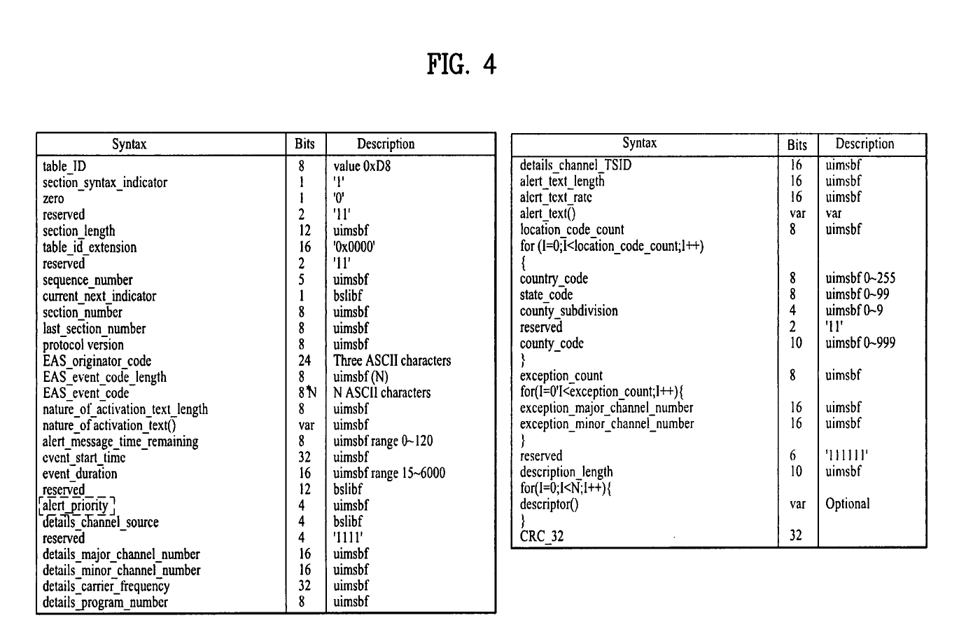

Yet, the EAT will be explained with reference to FIG. 4 later.

The tuner 204 records a result of receiving the broadcast signal in the channel manager 212.

The demodulator 205 is operative in modulating a signal tuned by the tuner 204 into a VSB/EVSB (vestigial side band/enhanced vestigial side band) signal.

The demultiplexer 206 is operative in demultiplexing the signal modulated by the demodulator 205 into audio data, video data and PSI/PSIP table data.

Demultiplexing of the audio/video data is controlled by the channel manager 212. And, demultiplexing of the PSI/PSIP table data is controlled by the PSI/PSIP decoder 211.

The demultiplexed PSI/PSIP table is transferred to the PSI/PSIP decoder 211. The demultiplexed audio/video data is transferred to the A/V decoder 207. And, the A/V decoder 207 decodes the received data.

The PSI/PSIP decoder 211 parses a PSI/PSIP section. The PSI/PSIP decoder 211 reads the rest of actual section data failing in section filtering of the demultiplexer 206 and then records the read data in the PSI/PSIP database 210.

The PSI/PSIP decoder 211 can parse EAT information included in the PSI/PSIP while parsing the PSI/PSIP section. In this case, according to the parsed information, the application & UI controller 213 controls the display unit 208 to output a text associated with an emergency.

The display unit 208 outputs audio or video data and outputs an OSD (on screen display) video.

Moreover, differing from a general broadcast receiver, the cable broadcast receiver 101 further includes the cable modem 29 and the cable card module 216 to receive a cable broadcast signal from the cable broadcasting station 102.

An emergency alert message (EAM) can be received via the OOB tuner 203 if a cable card is inserted in the cable broadcast receiver 101. If the cable card is not inserted in the cable broadcast receiver 101, the emergency alert message can be received via the IB tuner 202 as well.

The received emergency alert message can avoid an overlapping check of the received emergency alert message according to a reception band.

For instance, after a current emergency alert message has been received, if it is decided that a reception band of the current emergency alert message is different from a reception band of a previously received emergency alert message, it can be confirmed that a new emergency has occurred. Hence, by clearing “sequence_number” of an EAT shown in FIG. 4, an overlapping check of an emergency alert message needs not to be performed separately.

On the other hand, if the current emergency alert message is received via the same band of the previous emergency alert message, the overlapping check of an emergency alert message is carried out. As a result of the overlapping check, if it is an overlapped message, it can be confirmed that a new emergency has not occurred. Hence, it is unnecessary to process the emergency alert message anymore.

Meanwhile, since the cable broadcast receiver 101 is in a plugged-out mode, in case that a power is not supplied to the cable broadcast receiver 101 at all, the cable broadcasting station 102 decides whether the cable broadcast receiver 101 is in the plugged-out mode in a following manner.

First of all, the cable broadcasting station 102 can decide whether a plug of the cable broadcast receiver 101 is put into a socket using the fact that the cable broadcasting station 102 can bi-directionally communicate with the cable broadcast receiver 101 via the cable.

If the plug of the cable broadcast receiver 101 is put into the socket, the able card module 216 can detect that a cable card is in an active mode. And, the application & UI controller 213 can recognize the active mode of the cable card by transacting control signals with the cable card module 216.

In this case, if the cable broadcasting station 102 sends a request signal making a request for information indicating whether the cable card is in the active mode via the RF switch 201, the request signal is delivered to the application & UI controller 213 via the OOB tuner 203 or the cable modem 209.

In case of receiving the request signal, the application & UI controller 213 transfers information detecting that the cable card is in the active mode to the cable broadcasting station 102 via the cable modem 209 or the OOB tuner 203.

This considers that bi-directional communications can be achieved between the cable broadcast receiver 101 and the cable broadcasting station 102 via the cable modem or OOB tuner 209 or 203 of the cable broadcast receiver 101.

Meanwhile, in case that the plug of the cable broadcast receiver 101 is not put into the socket, a signal flow of the plugged cable broadcast receiver 101 is not generated.

Hence, the cable broadcasting station 102 transfers a signal that requests information indicating whether the cable card is in the active mode to the cable broadcast receiver 101. If any response signal is not received from the cable broadcast receiver 101, the cable broadcasting station 102 decides that the cable broadcast receiver 101 is in the plugged-out mode.

As a result of the decision made by the cable broadcasting station 102, if the cable broadcast receiver 101 is in the plugged-out mode, the cable broadcast receiver 101 is unable to receive an emergency alert message despite that an emergency has occurred. Hence, the cable broadcasting station 102 transmits information associated with the emergency not to the plugged-out cable broadcast receiver 101 but to the EAM receiving medium 103 as a different medium.

The cable broadcasting station 102 can transmit the information associated with emergency to the EAM receiving medium 103 by wire or wireless communications.

If the EAM receiving medium 103 is a wire phone for example, the emergency occurrence news can be outputted as sound. If the EAM receiving medium 103 is a mobile phone or PDA (personal digital assistants) for example, the emergency occurrence news can be outputted as at least one of sound and text.

Namely, no special limitation is put on the EAM receiving medium 103. All kinds of devices, which can receive and output the emergency associated information if the cable broadcast receiver 101 is in the plugged-out mode, can become the EAM receiving medium 103.

Meanwhile, the cable broadcasting station 102 decides a specific type of the EAM receiving mode 103 to transmit the emergency associated information in the following two manners for example.

First of all, a user of the cable broadcast receiver 101 subscribes for the cable broadcasting station 102 to watch cable broadcasting. The type of the EAM receiving medium 103 is randomly decided using the user information acquired from the subscription.

For instance, in case that user's home or mobile phone number is registered as the user information, the cable broadcasting station 102 transmits the emergency associated information to a phone of the user's home phone number or a mobile phone of the user's mobile phone number. So, the home or mobile phone having received the information outputs the received information in at least one of audio and video data formats.

Secondly, a user can set a type of the EAM receiving medium 103 by himself.

For instance, in case that the cable broadcast receiver 101 is in the plugged-out mode, the user directly designates a specific phone, a mobile phone, a PC, a laptop, a PDA or the like as the EAM receiving medium 103 to receive the emergency associated information.

Of course, the first and second methods can be combined together as well. In particular, the type of the EAM receiving medium 103 is preferentially decided using the previously registered information of the user. Yet, if no information of the user exists or if the user intends to change the information randomly, the type of the EAM receiving medium 103 is set changeable.

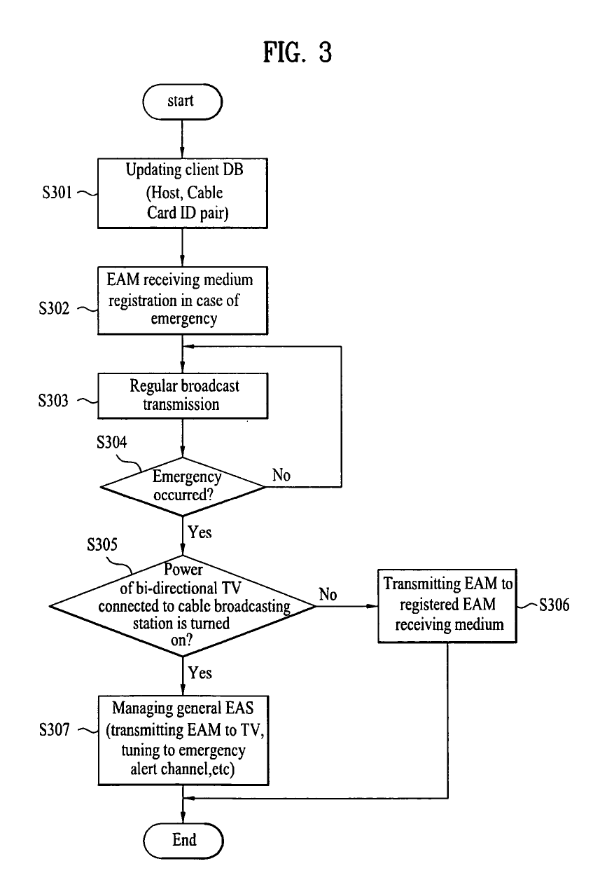

FIG. 3 is a flowchart of a method of processing an emergency alert message in bi-directional cable digital broadcasting according to one embodiment of the present invention. A method of transmitting an emergency alert message to a different medium in case that a cable broadcast receiver is in a plugged-out mode is explained in a sequence of time flow with reference to FIG. 3 as follows.

Referring to FIG. 3, a unique ID granted cable card is lent to a user of a receiver capable of receiving cable digital broadcasting if the user subscribes for a cable broadcasting station (not shown in the flowchart).

The cable broadcasting station 102 maintains and manages a pair of the lent cable card's ID and a host ID of the user's cable broadcast receiver using a database IS301).

In case that an EAM (emergency alert message) needs to be transmitted due to an emergency occurrence, if the cable broadcast receiver 101 is in a plugged-out mode, an EAM receiving medium 103 capable of receiving the EAM instead of the cable broadcast receiver 101 is registered to the cable broadcasting station 102 (S302).

The EAM contains information associated with an emergency and can be outputted in at least one of audio and video data formats.

The EAM receiving medium 103 is registered to the cable broadcasting station 102 in the aforesaid manner. In particular, a phone number registered in subscribing for the cable broadcasting station is used for the registration. Alternatively, an EAM receiving medium 103 newly changed and registered by a user in direct is used for the registration.

The cable broadcasting station 102 transmits regular broadcasting to the cable broadcast receiver 101 having subscribed for the cable broadcasting station (S303).

The cable broadcasting station 102 decides whether an emergency occurs using an EAT (emergency alert table) while transmitting regular broadcasting (S304).

As a result of the decision (S304), if the emergency does not occur, the cable broadcasting station 102 keeps transmitting the regular broadcasting normally.

As a result of the decision (S304), in case that the emergency has occurred, the cable broadcasting station 102 decides whether the cable broadcast receiver 101 subscribed for the cable broadcasting station 102 is in a plugged-in mode (S305).

As mentioned in the foregoing description of FIG. 2, the deciding step S305 is carried out in a following manner. First of all, while transmitting regular broadcasting to the cable broadcast receiver 101 subscribed for the cable broadcasting station 102, if an emergency situation occurs, the cable broadcasting station 102 periodically polls a signal inquiring whether the cable card, which is lent to the cable broadcast subscriber and is loaded in the cable broadcast receiver 101, is in an active mode. If a response signal is not received within a predetermined duration, it is decided that the subscriber's cable broadcast receiver 101 (e.g., host TV) is in an plugged-out mode.

As a result of the decision (S305), if the cable broadcast receiver 101 subscribed for the cable broadcasting station 102 is in the plugged-out mode, a message containing emergency associated information is transmitted to the registered EAM receiving medium 103 (S306).

In this case, the emergency associated information can be outputted in at least one of audio and video data formats via the EAM receiving medium 103.

A user recognizing a situation of the emergency occurrence via the EAM receiving medium 103 or the like can put a plug of the cable broadcast receiver 101 into a socket to turn on a power to acquire detailed information of the emergency. Hence, the turned-on cable broadcast receiver 101 is automatically tuned to an emergency alert channel to provide more information to a viewer.

Meanwhile, as a result of the decision (S305), in case that the cable broadcast receiver 101 subscribed for the cable broadcasting station 102 is in the plugged-in mode, the cable broadcast receiver 101 receives an EAT associated with the emergency and the like (S307).

FIG. 4 is a diagram of a bit stream syntax of an emergency alert table (EAT) according to one embodiment of the present invention.

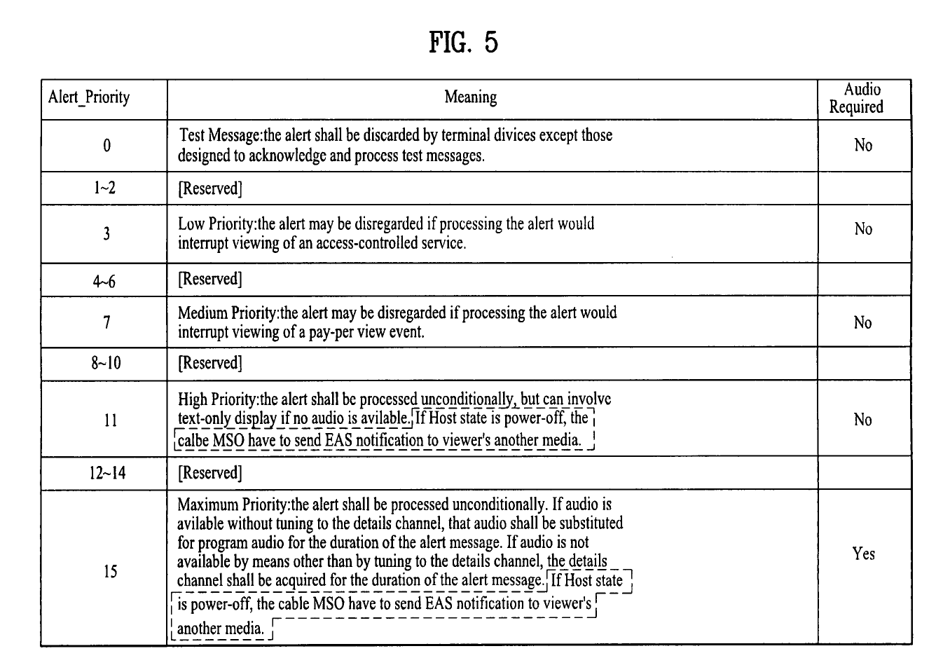

FIG. 5 is a diagram of a meaning of “alert_Priority” value according to one embodiment of the present invention.

A method of transmitting emergency associated information to an EAM receiving medium according to an urgent extent, a significant extent and the like of an emergency despite a plugged-out mode of a cable broadcast receiver is explained with reference to FIG. 4 and FIG. 5 as follows.

In this case, an EAT can be defined by a PSIP (program and system information protocol) and the like in cable broadcasting.

The EAT is transmitted from a cable broadcasting station 102. A cable broadcast receiver 101 then parses the transmitted EAT to decide whether an emergency has occurred.

In the present invention, “alert_priority” shall be newly defined. In particular, the EAT can be directly utilized by the cable broadcast receiver 101.

And, the “alert_priority” means a syntax representing a priority or significance.

A method of using an EAM receiving medium 103, a shown in FIG. 5, is appended for an pulled-out mode of the cable broadcast receiver 101.

For instance, if the cable broadcast receiver 101 is in the plugged-out mode and if “alert_priority” has a value equal to or greater than ‘11’ (high priority, maximum priority), the emergency associated information is transmitted to the EAM receiving medium 103.

This is not to transmit the emergency associated information is to the EAM receiving medium 103 if the priority of the emergency is relatively low (low priority, medium priority).

And, it is a matter of course that the emergency associated information can be set to be transmitted to the EAM receiving medium 103 in case of an occurrence of any kind of emergency.

### Second Embodiment

FIG. 2 is a block diagram of a broadcast receiver equipped with an emergency alert message processing function in bi-directional cable digital broadcasting according to one embodiment of the present invention.

FIG. 4 is a diagram of a bit stream syntax of an emergency alert table according to one embodiment of the present invention.

A method of operating an emergency alert system in case of a standby mode of a cable broadcast receiver and the like is explained with reference to FIG. 2 and FIG. 4 as follows.

First of all, the second embodiment of the present invention mainly deals with an EAS operating method for the case of a plugged-in cable broadcast receiver in a standby mode or for the case of a cable broadcast receiver that is outputting another input source (e.g., data output via DVD player), which differs from the first embodiment of the present invention dealing with the EAS operating method for the case of the plugged-out broadcast receiver.

Of course, the first and second embodiments of the present invention can be separately implemented or can be combined together to be implemented as one invention.

Besides, elements shown in FIG. 2 are already explained in the description of the first embodiment of the present invention. Hence, detailed description of the elements shown in FIG. 2 will be skipped in the following.

The microcomputer 217, as shown in FIG. 2, is operated when the plugged-in cable broadcast receiver 101 is in a standby mode. This is because in the standby mode of the cable broadcast receiver 101, an operational power of the microcomputer 217 should be in an active mode to control other elements by receiving signals of a remote controller and the like.

Hence, in the standby mode of the cable broadcast receiver 101, the microcomputer 217 can control other elements to operate them under its control.

In case that the cable broadcast receiver 101 is in the standby mode, the microcomputer 217 controls the channel manager 212. And, the channel manager 212 controls the tuner 204 to be tuned to a predetermined emergency alert channel periodically.

The emergency alert channel is a channel carrying news associated with an emergency. The emergency alert channel can employ a conventional frequency channel of a broadcasting station or can be set to a new frequency channel additionally.

Over the emergency alert channel, an EAT (emergency alert table) containing information about a presence or non-presence of an emergency occurrence, a priority of an emergency and the like to the cable broadcast receiver 101. An example of the EAT is shown in FIG. 4.

The PSI/PSIP decoder 211 decides a presence or non-presence of an emergency occurrence, a priority of an emergency and the like by parsing the EAT transmitted from the cable broadcasting station 102. According to a decision result, an emergency associated text is outputted via the display unit 208. Or, the cable broadcast receiver 101 is switched to a normal mode from the standby mode and is then tuned to the emergency alert channel by controlling the tuner 204.

In this case, the normal mode means a state that a cable broadcast video is outputted via a screen of the cable broadcast receiver 101.

FIG. 5 is a diagram of a meaning of “alert_Priority” value according to one embodiment of the present invention.

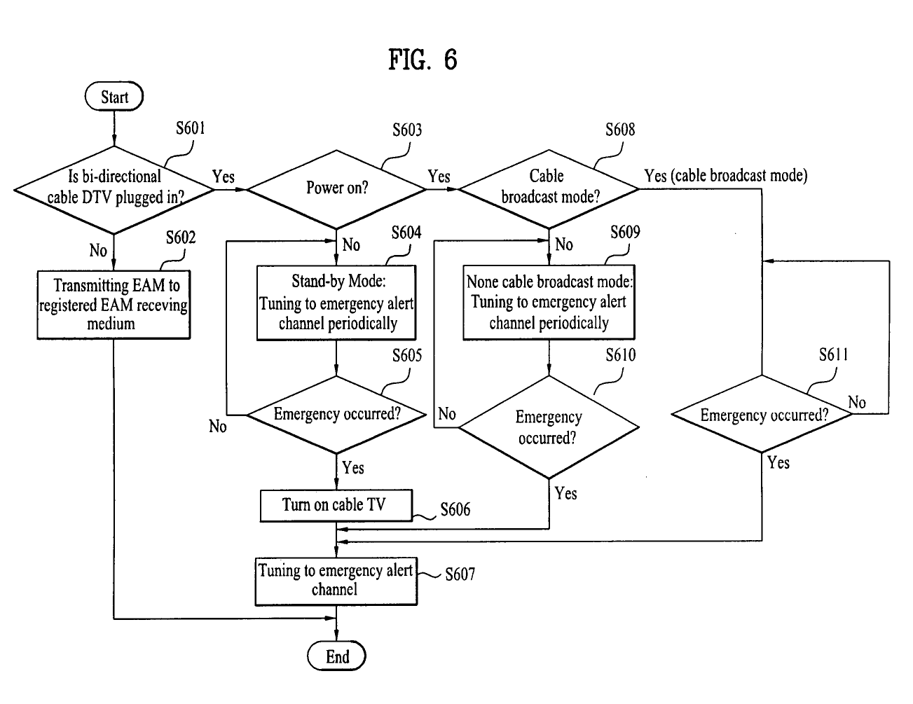

FIG. 6 is a flowchart of a method of processing an emergency alert message in bi-directional cable digital broadcasting according to another embodiment of the present invention.

A method of operating an emergency alert system is explained in a time flow sequence with reference to FIG. 5 and FIG. 6 as follows. In this case, 1) a cable broadcast receiver is in a plugged-out mode, 2) a plugged-in cable broadcast receiver is in a standby ode, 3) a plugged-in cable broadcast receiver outputs an external input source, or 4) a plugged-in cable broadcast receiver outputs a cable broadcast.

First of all, it is decided whether a cable broadcast receiver 101 is in a plugged-in mode (S601). N this case, the cable broadcast receiver 101 includes a bi-directional cable DTV or the like for example.

As a result of the decision (S601), if the cable broadcast receiver 101 is not in the plugged-in mode but in a plugged-out mode, an emergency alert message is transmitted to a registered EAM receiving medium 103 (S602).

Yet, the steps S601 and S602 are explained in the description of the first embodiment of the present invention, of which detailed explanation will be skipped in the following description.

As a result of the decision (S601), if the cable broadcast receiver 101 is in the plugged-in mode, it is decided whether the cable broadcast receiver 101 is in a standby mode (S603).

In the standby mode, the cable broadcast receiver 101 is not operative in video output and the like since a power of the cable broadcast receiver 101 is turned off despite that a plug of the cable broadcast receiver 101 is put into a socket.

As a result of the decision (S603), if the cable broadcast receiver 101 is in the standby mode, the tuner 204 is controlled to be periodically tuned to an emergency alert channel (S604).

The emergency alert channel is a channel carrying news associated with an emergency. The emergency alert channel can employ a conventional frequency channel of a broadcasting station or can be set to a new frequency channel additionally. In particular, the emergency alert channel means a channel carrying such a table as an EAT (emergency alert table) and the like.

The tuner 204 is periodically tuned to the emergency alert channel and the PSI/PSIP decoder 211 decides whether an emergency has occurred by parsing the EAT and the like (S605).

As a result of the decision (S605), in case that the emergency has occurred, a power of the cable broadcast receiver 101 is turned on (S606).

According to an urgent or significant extent (not shown in “alert_priority” of FIG. 5), a power of the cable broadcast receiver 101 can be set to be turned on or to maintain the standby mode.

For instance, in the table shown in FIG. 5, only if “alert_Priority” has a value equal to or greater than 11 (high priority, maximum priority), the power of the cable broadcast receiver 101 is turned on. If “alert_Priority” has a value smaller than 11, the cable broadcast receiver 101 is kept in the standby mode.

Namely, in case that the priority of the emergency is relatively low (low priority, medium priority), it is convenient for a user to keep the power of the cable broadcast receiver 101 in the standby mode.

Alternatively, it can be designed that the power of the cable broadcast receiver 101 is turned on in case of any emergency occurrence.

By continuously keeping the cable broadcast receiver 101 tuned to the emergency alert channel, emergency associated information received over the emergency alert channel is provided to a user. Of course, if a user tunes the cable broadcast receiver 101 to another channel, the cable broadcast receiver 101 is tuned to the corresponding channel according to a user's manipulation.

As a result of the decision (S603), if the cable broadcast receiver 101 is not in the standby mode but in a power-on mode, it is decided whether the cable broadcast receiver 101 is outputting a received cable broadcast (S608).

As a result of the decision (S608), if the cable broadcast receiver 101 is outputting not the cable broadcast but another input source (e.g., A/V data output via DVD player), the tuner 204 is controlled to be periodically tuned to the emergency alert channel (S609).

The tuner 204 is periodically tuned to the emergency alert channel and the PSI/PSIP decoder 211 decides whether an emergency has occurred by parsing the EAT and the like (S610).

As a result of the decision (S610), in case that the emergency has occurred, a tuning to the emergency alert channel is continuously maintained to provide emergency associated information received over the emergency alert channel to a user (S607).

Of course, if a user tunes the cable broadcast receiver 101 to another channel, the cable broadcast receiver 101 is tuned to the corresponding channel according to a user's manipulation.

According to an urgent or significant extent (not shown in “alert_priority” of FIG. 5), it can be designed that the cable broadcast receiver 101 keeps outputting another input source instead of being switched to the emergency alert channel if the urgent or significant extent is relatively low.

If a user is viewing A/V data outputted via specific external input source, the currently viewed A/V data may be very important. Hence, by controlling the cable broadcast receiver 101 to be tuned to the emergency alert channel only in case of a relatively very high significance of the emergency, user's convenience can be enhanced.

As a result of the decision (S608), if a cable broadcast is being outputted, the PSI/PSIP decoder 211 decides whether an emergency has occurred by parsing the EAT and the like (S611).

The decision of the step S611 is enabled because information containing EAT and the like can be received via the tuner 204 in cable broadcasting no matter what cable broadcast channel a user is watching.

As a result of the decision (S611), in case that an emergency has occurred, the broadcast receiver 101 is tuned to the emergency alert channel to provide emergency associated information to a user (S607).

Of course, if a user tunes the cable broadcast receiver 101 to another channel, the cable broadcast receiver 101 is tuned to the corresponding channel according to a user's manipulation.

According to an urgent or significant extent (not shown in “alert_Priority” of FIG. 5), it can be designed that the cable broadcast receiver 101 keeps outputting the currently-viewed cable broadcast instead of being switched to the emergency alert channel if the urgent or significant extent is relatively low.

If a user of the cable broadcast receiver 101 is viewing a pay-per-view cable broadcast or an expensive cable broadcast charging a separate contents view, the currently viewed video may be more important than the emergency associated video.

Hence, by controlling the cable broadcast receiver 101 to be tuned to the emergency alert channel only in case of a relatively very high significance of the emergency, user's convenience can be enhanced.

Meanwhile, terminologies used in the description of the present invention are defined as considering functions in the present invention, which are variable according to usual practice or intentions of those who skilled in the art. Hence, their definitions shall be given based on the overall contents of the present invention.

Accordingly, the present invention provides the following effects.

Firs of all, if the power of the broadcast receiver capable of receiving cable digital broadcasting is turned off and if the broadcast receiver is in the plugged-out mode, the information indicating the emergency occurrence can be notified to a user.

Secondly, if the power of the broadcast receiver capable of receiving cable digital broadcasting is turned on and if the broadcast receiver is in the standby mode or is outputting another data input source (e.g., outputting A/V data received from DVD player), the information indicating the emergency occurrence can be notified to a user.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. An emergency alert signaling method for use by a digital cable broadcast system, the method comprising:
determining whether a digital television receiver is plugged into a power supply;
determining whether an emergency alert event is taken place if the digital television receiver is not plugged into the power supply; and
transmitting a new emergency alert message associated with the emergency alert event to an alternative data receiver if the emergency alert event is taken place.

2. The method of claim 1, wherein determining whether a digital television receiver is plugged into a power supply comprises:
transmitting a status request to the digital television receiver to determine whether a cable card included in the digital television receiver is active; and
determining that the digital television receiver is not plugged into the power supply if no response is received from the digital television receiver.

3. The method of claim 2, wherein transmitting a status request to the digital television receiver comprises transmitting a status request to a cable modem included in the digital television receiver.

4. The method of claim 2, wherein transmitting a status request to the digital television receiver comprises transmitting a status request to an out of band (OOB) tuner included in the digital television receiver.

5. The method of claim 1, wherein transmitting a new emergency alert message comprises transmitting the new emergency alert message based upon an alert priority of the emergency alert event.

6. A digital cable broadcast system comprising:
a broadcast receiver;
a broadcast transmitter transmitting a new emergency alert message associated with an emergency alert event if the broadcast receiver is not plugged into a power supply; and
an alternative data receiver receiving the new emergency alert message and displaying the new emergency alert message.

7. The digital cable broadcast system of claim 6, wherein the broadcast transmitter transmits a status request to the digital television receiver to determine whether a cable card included in the broadcast receiver is active, and determines that the broadcast receiver is not plugged into the power supply if no response is received from the broadcast receiver.

8. The digital cable broadcast system of claim 7, wherein the broadcast transmitter transmits the status request to a cable modem included in the broadcast receiver.

9. The digital cable broadcast system of claim 7, wherein the broadcast transmitter transmits the status request to an out of band (OOB) tuner included in the broadcast receiver.

10. The digital cable broadcast system of claim 6, wherein the broadcast transmitter transmits the new emergency alert message according to an alert priority of the emergency alert event.

11. An emergency alert signaling method for use by a digital cable television receiver, the method comprising:
plugging the digital cable television receiver into a power supply by a user when an emergency alert message received by an alternative data receiver;
determining whether the television receiver is on a power-on mode or power-off mode;
periodically tuning to a predefined emergency alert channel to receive a first emergency alert table when the television receiver is on the power-off mode;
parsing the first emergency alert table to determine whether the first emergency alert table includes a new emergency alert message; and
automatically setting the television receiver on the power-on mode and tuning to the emergency alert channel when the parsed first emergency alert table includes the new emergency message.

12. The method of claim 11, wherein the first emergency alert table includes an information field specifying a sequence number of the new emergency alert message.

13. The method of claim 11, further comprising parsing the new emergency alert message from the first emergency alert table and scrolling the parsed new emergency alert message across a portion of a video screen.

14. The method of claim 11, further comprising:
determining whether the television receiver is currently on a cable broadcast mode when the television receiver is on the power-on mode;
periodically tuning to the emergency alert channel to receive a second emergency alert table when the television receiver is not on the cable broadcast mode;
parsing the second emergency alert table to determine whether the second emergency alert table includes a new emergency alert message; and
automatically tuning to the emergency alert channel when the parsed second emergency alert table includes the new emergency alert message.

15. The method of claim 14, wherein the second emergency alert table includes an information field specifying a sequence number of the new emergency alert message.

16. The method of claim 14, further comprising parsing the new emergency message from the second emergency alert table and scrolling the parsed new emergency alert message across a portion of a video screen.

17. The method of claim 11, further comprising:
determining whether the television receiver is currently on a cable broadcast mode when the television receiver is on the power-on mode;
periodically tuning to the emergency alert channel to receive a second emergency alert table when the television receiver is on the cable broadcast mode;
parsing the second emergency alert table to determine whether the second emergency alert table includes a new emergency alert message; and
automatically tuning to the emergency alert channel when the parsed second emergency alert table includes the new emergency alert message.

18. The method of claim 17, wherein the second emergency alert table includes an information field specifying a sequence number of the new emergency alert message.

19. The method of claim 17, further comprising parsing the new emergency message from the second emergency alert table and scrolling the parsed new emergency alert message across a portion of a video screen.
